(19) United States
(12) Patent Application Publication
(10) Pub. No.: US 2008/0121495 A1
(43) Pub. Date: May 29, 2008

(54) OBLIQUE-ROLLER BELT CONVEYOR WITH SIDEGUARD

(76) Inventors: Eric M. Pressler, New Orleans, LA (US); Mark Costanzo, River Ridge, LA (US); Matthew L. Fourney, Laurel, MD (US)

Correspondence Address: LAITRAM, L.L.C.;LEGAL DEPARTMENT, 220 LAITRAM LANE, HARAHAN, LA, 70123, US

(21) Appl. No.: 11/564,407

(22) Filed: Nov. 29, 2006

(51) Int. Cl. B65G 47/24

(52) U.S. Cl. 198/411

(57) ABSTRACT

An alignment conveyor for aligning articles along a side of the conveyor without changing their orientation. The conveyor includes a conveyor belt having article-supporting rollers rotating in a direction oblique to the direction of belt travel as the belt advances. The rollers direct the articles to a side of the belt. A sideguard, formed by a series of plates or an array of rotatable elements, advances with the belt in the direction of belt travel and receives and aligns the articles without causing them to rotate on contact.

### BACKGROUND

The invention relates generally to power-driven conveyors and, more particularly, to conveyors using a conveyor belt having article-supporting rollers rotating oblique to the direction of belt travel to translate conveyed articles to a side of the conveyor.

Conveyor belts with rollers extending through the thickness of the belt and arranged to rotate on axes oblique to the belt's direction of travel are used in conveyors to align articles along a side of the conveyor. The oblique rollers ride on bearing surfaces supporting the conveyor belt 10 from below to push articles 12 conveyed atop the rollers 14 toward a side 16 of the belt as it advances, as shown in FIG. 5. When the longer side 18 of a rectangular article is leading, the article tends to rotate on contact with a stationary side rail 20 because of friction between the article and the side rail. The article orients itself in the most stable position with the shorter side 19 leading. In many applications, it is important for all articles to be conveyed and aligned with the longer edge leading.

Thus, there is a need for a belt conveyor that can align conveyed articles without changing their orientations.

### SUMMARY

This need and other needs are satisfied by a conveyor embodying features of the invention including a conveyor belt advancing in a direction of belt travel and having a plurality of rollers extending through its thickness. The rollers are arranged to rotate in a direction oblique to the direction of belt travel. A bearing surface underlying the conveyor belt in contact with the rollers causes the rollers to rotate as the conveyor belt advances. The obliquely oriented rotating rollers translate articles conveyed atop the rollers toward a side of the conveyor belt. A sideguard, disposed along the side of the conveyor belt and extending above the rollers, advances with the conveyor belt in the direction of belt travel to receive conveyed articles translated toward the side.

In another aspect of the invention, a conveyor comprises a conveyor belt advancing in a direction of belt travel. The belt has an outer surface and an opposite inner surface extending laterally to opposite first and second sides of the conveyor belt. Rollers in the conveyor belt are arranged to rotate on axes oblique to the direction of belt travel. Salient portions of the rollers extend past the outer and inner surfaces of the conveyor belt. A bearing surface contacting the salient portions of the rollers extends past the inner surface of the conveyor belt and causes the rollers to rotate on their oblique axes as the conveyor belt advances in the direction of belt travel. The rotation of the rollers directs articles conveyed atop the salient portions of the rollers extending past the outer surface of the conveyor belt toward the first side of the conveyor belt. A sideguard upstanding from the outer surface of the conveyor belt along the first side receives articles directed toward the first side of the conveyor belt atop the rollers.

In yet another aspect of the invention, a conveyor comprises a conveyor belt having article-supporting belt rollers capable of rotating, as the conveyor belt advances in a direction of belt travel, in a direction oblique to the direction of belt travel. A sideguard stands up from the conveyor belt along the belt's side.

### BRIEF DESCRIPTION OF THE DRAWINGS

These features and aspects of the invention, as well as its advantages, are better understood by reference to the following description, appended claims, and accompanying drawings, in which:

FIG. 1 is an isometric view of a portion of a conveyor embodying features of the invention, including a sideguard comprising a series of plates;

FIG. 2 is an isometric view of a portion of another version of conveyor embodying features of the invention, including a sideguard having stacks of wheels;

FIG. 3 shows top plan, side elevation, and front elevation views of the conveyor of FIG. 2;

FIG. 4 is an isometric view of a portion of the conveyor of FIG. 2 further showing a vertical bearing surface for rotating the sideguard wheels as the conveyor belt advances; and

FIG. 5 is a top plan view of an oblique-roller belt operated in a conventional way in a conveyor with a stationary side rail.

### DETAILED DESCRIPTION

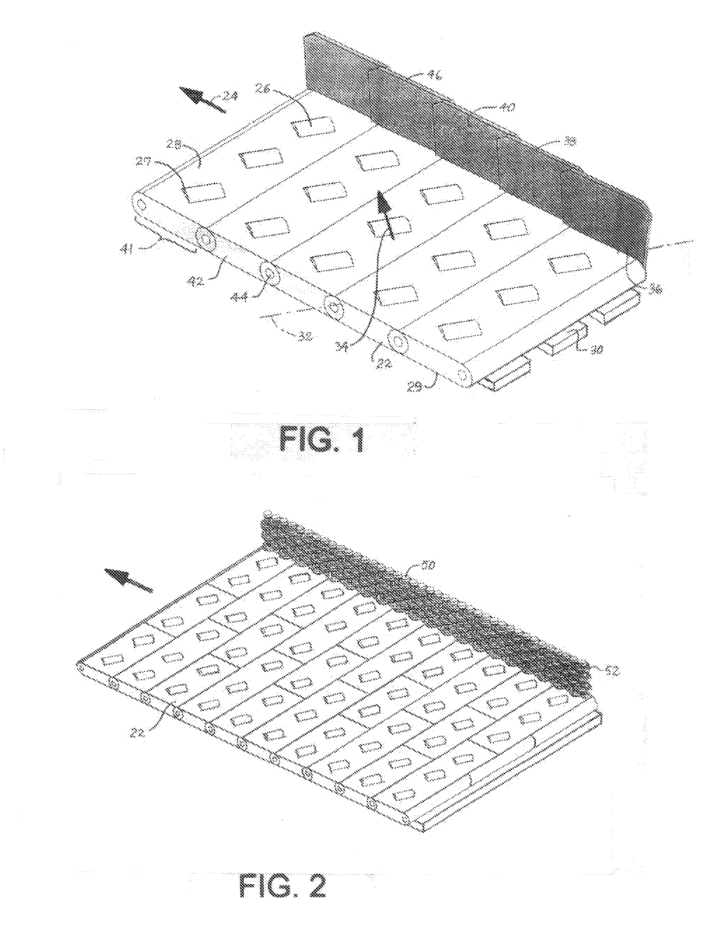

A portion of one version of a conveyor embodying features of the invention is shown in FIG. 1. The conveyor includes a conveyor belt 22 driven in a direction of belt travel 24. Rollers 26 retained in the belt, such as in cavities 27, extend past outer 28 and inner 29 belt surfaces. Salient portions of the rollers extending past the outer, or top, surface support articles conveyed on the belt. Salient portions of the rollers extending past the inner, or bottom, surface of the belt roll on roller bearing surfaces 30 below the belt. The rollers are arranged to rotate on axes 32 oblique to the direction of belt travel, defined, for example, by axles extending through bores in the rollers and retained in the body of the belt. As the belt advances in the direction of belt travel, the rollers rotate on their axes in an oblique direction 34, pushing articles conveyed atop the rollers toward a side 36 of the belt. A sideguard 38 at the side of the belt provides a vertical registration surface 40, against which articles translated to the side are aligned. In this example, the belt is a modular plastic conveyor belt constructed of a series of rows 40 of belt modules 42. The rows are joined to an adjacent leading and trailing rows at hinge joints 44 that allow the belt to articulate about drive and idle sprockets and to backbend. (A hinge joint is formed in the conventional manner by the interleaved hinge eyes of adjacent rows journaling a hinge pin.) The sideguard constitutes a series of individual plates 46. Each plate extends upward from the outer surface of a row at the side of the belt to which conveyed articles are directed by the rollers. The plates provide the sideguard with the registration surface 40. The plates may be mechanically attached to the belt modules or unitarily molded with them. Because the sideguard advances in the direction of belt travel with the belt, the sideguard engages articles translated to the side with les friction than a stationary conveyor side rail would. Consequently, a rectangular article being conveyed with its longer edge leading is less likely to rotate on contact with alignment structure at the side of the belt.

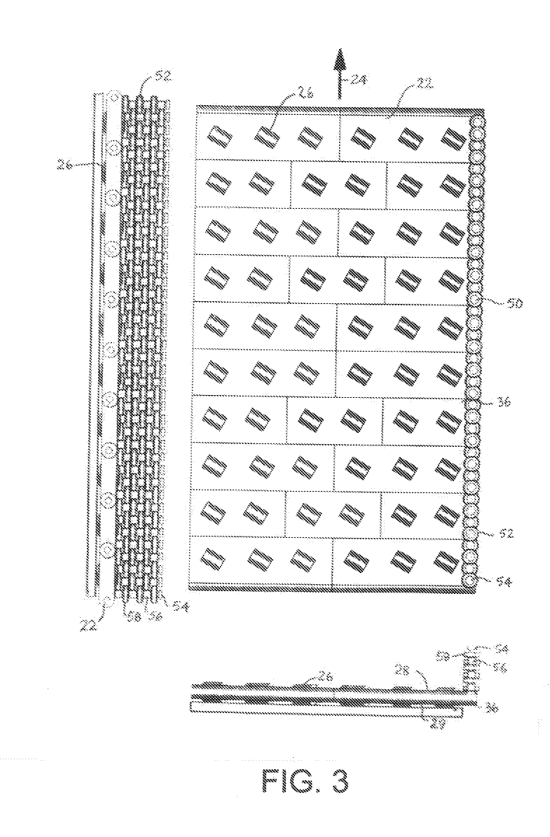

A sideguard 50 presenting an array of rotatable elements, such as wheels 52, is shown in the conveyor of FIGS. 2 and 3. The wheels are mounted on posts 54 spaced along the length of the conveyor belt 22 at the side 36 of the belt toward which the article-supporting rollers 26 direct the articles. The posts extend perpendicularly upward from the outer surface 28 of the belt. The wheels are stacked on the posts, which extend through central bores in the wheels. The posts serve as axles on which the portions of the wheels facing the belt rotate in the direction of belt travel. The wheels have hubs 56 on one side. The hubs are used to space the larger-diameter wheel treads 58 in each stack on the post. The wheels on consecutive posts are stacked oppositely. On even-numbered posts, the wheels are stacked with the hubs above the treads; on odd-numbered posts, the wheels are stacked with the hubs below the treads. This allows the wheels to be closely packed in an array with the treads on one post vertically offset from the treads of the wheels on an adjacent post and with the wheels on adjacent posts overlapping vertically. In this way, the wheel array forms a low-friction alignment surface for the articles. The wheels in FIGS. 2 and 3 are free to rotate on contact with the translated article. The low-friction rolling engagement allows the sideguard to receive translated articles without causing them to rotate.

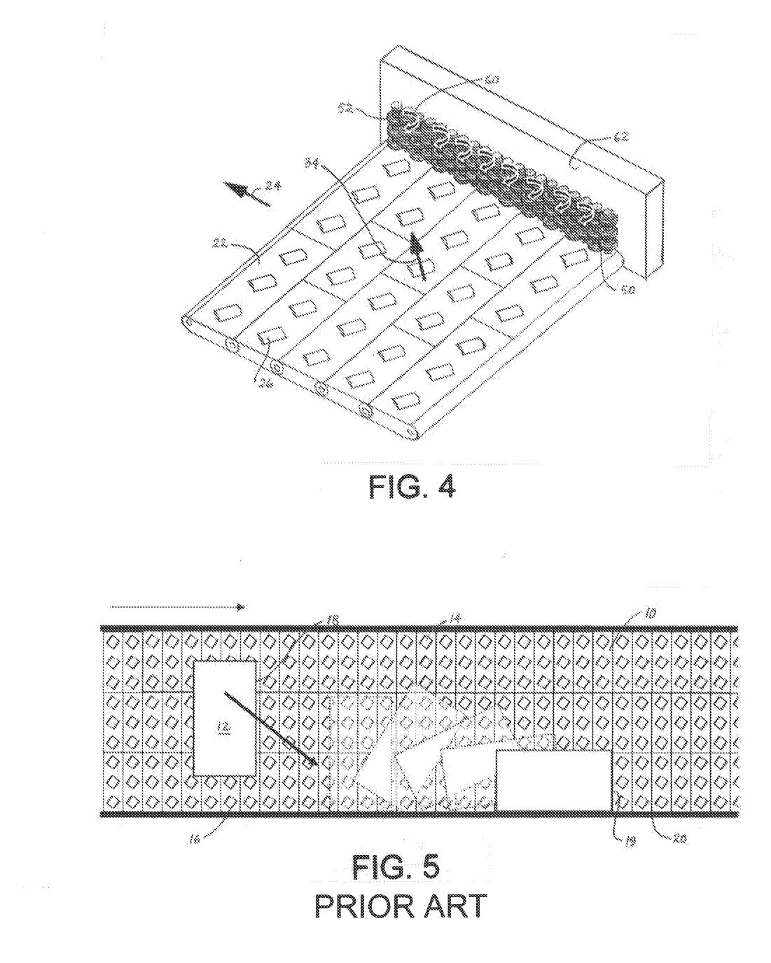

As shown in FIG. 4, the wheels of the sideguard 50 in FIGS. 2 and 3 can be rotated as shown by arrow 60 by contact with a vertical wheel bearing surface 62. As the belt 22 advances in the direction of belt travel 24, the treads of the wheels 52 roll on the stationary vertical bearing surface. This causes the wheels to rotate in the direction of belt travel at their points of contact with conveyed articles. Because articles are being translated by the belt rollers 26 with a component of motion relative to the belt in the direction of belt travel and because the wheels are also rotating in the direction of belt travel where they contact the articles, any tendency of the articles to rotate is eliminated.

Although the invention has been described in detail with respect to a few preferred versions, other versions are possible. For example, the individual linear wearstrips providing the roller bearing surfaces in FIG. 1 may be replaced by a single bearing plate, as in FIGS. 2-4, or by support rollers engaging the belt rollers from below in rolling contact. As another example, the sideguards described are attached to the belt. But sideguards that move in the direction of belt travel at the side of the belt, but not physically attached to the belt may also be used. As yet another example, roller balls retained in a side wall could be used as rotatable elements in the sideguard instead of wheels on posts. And, the belt could be a flat belt as well as the modular belt used in describing the invention. So, as these few examples suggest, the scope of the claims is not meant to be limited to the preferred versions.

1. A conveyor comprising:
a conveyor belt advancing in a direction of belt travel and having a plurality of rollers extending through the thickness of the conveyor belt arranged to rotate in a direction oblique to the direction of belt travel;
a bearing surface underlying the conveyor belt in contact with the rollers and causing the rollers to rotate as the conveyor belt advances to translate articles conveyed atop the rollers toward a side of the conveyor belt;
a sideguard disposed along the side of the conveyor belt and extending above the rollers and advancing with the conveyor belt in the direction of belt travel to receive conveyed articles translated toward the side.

2. A conveyor as in claim 1 wherein the sideguard comprises a series of plates upstanding from the conveyor belt along the side.

3. A conveyor as in claim 1 wherein the sideguard comprises a series of rotatable elements rotatable in the direction of belt travel.

4. A conveyor as in claim 3 further comprising a second bearing surface proximate the side of the conveyor belt and wherein the rotatable elements rotate by contact with the second bearing surface as the conveyor belt advances.

5. A conveyor as in claim 1 wherein the sideguard comprises a series of wheels mounted to the conveyor belt for rotation on axes disposed perpendicular to the direction of belt travel.

6. A conveyor as in claim 1 wherein the sideguard comprises a series of posts upstanding from the conveyor belt and one or more wheels received on each post for rotation about the post.

7. A conveyor comprising:
a conveyor belt advancing in a direction of belt travel and including:
an outer surface and an opposite inner surface extending laterally to opposite first and second sides of the conveyor belt;
a plurality of rollers arranged to rotate on axes oblique to the direction of belt travel, the rollers having salient portions extending past the outer and inner surfaces of the conveyor belt;
a bearing surface contacting the salient portions of the rollers extending past the inner surface of the conveyor belt and causing the rollers to rotate on their oblique axes as the conveyor belt advances in the direction of belt travel, the rotation of the rollers directing articles conveyed atop the salient portions of the rollers extending past the outer surface of the conveyor belt toward the first side of the conveyor belt;
a sideguard upstanding from the outer surface of the conveyor belt along the first side to receive articles directed toward the first side of the conveyor belt atop the rollers.

8. A conveyor as in claim 7 wherein the sideguard comprises a series of plates upstanding from the outer surface of the conveyor belt along the first side.

9. A conveyor as in claim 7 wherein the sideguard comprises a series of rotatable elements rotatable in the direction of belt travel.

10. A conveyor as in claim 9 further comprising a second bearing surface proximate the first side of the conveyor belt and wherein the rotatable elements rotate in the direction of belt travel by contact with the second bearing surface as the conveyor belt advances in the direction of belt travel.

11. A conveyor as in claim 7 wherein the sideguard comprises a series of wheels mounted to the conveyor belt for rotation on axes disposed perpendicular to the outer surface of the conveyor belt.

12. A conveyor as in claim 7 wherein the sideguard comprises:
a series of posts upstanding from the outer surface of the conveyor belt spaced apart along the first side; and
one or more wheels received on each post for rotation about the post.

13. A conveyor as in claim 12 wherein the wheels are stacked on the posts and wherein the wheels on consecutive posts are vertically offset from each other.

14. A conveyor as in claim 12 wherein the wheels on consecutive posts overlap each other vertically.

15. A conveyor comprising:
a conveyor belt having article-supporting belt rollers capable of rotating, as the conveyor belt advances in a direction of belt travel, in a direction oblique to the direction of belt travel;
a sideguard upstanding from the conveyor belt along a side of the conveyor belt.

16. A conveyor as in claim 15 wherein the sideguard includes an array of rotatable elements arranged to rotate in the direction of belt travel.

17. A conveyor as in claim 16 further including a vertical bearing surface contacting the rotatable elements outward of the conveyor belt to cause the rotatable elements to rotate in the direction of belt travel as the conveyor belt advances.

18. A conveyor as in claim 15 wherein the conveyor belt includes a series of rows of belt modules hingedly joined and wherein the sideguard includes an upstanding plate connected to each row at a side of the conveyor belt.

19. A conveyor as in claim 15 wherein the conveyor belt includes a series of rows of belt modules hingedly joined and wherein the sideguard includes at least one post upstanding from the conveyor belt at a side of each row and at least one wheel rotatably mounted on each post.
